(19) United States
(12) Patent Application Publication
(10) Pub. No.: US 2026/0359646 A1
(43) Pub. Date: Nov. 12, 2026

(54) MOBILITY APPARATUS AND METHOD FOR GENERATING TRANSMISSION OR RECEPTION SIGNAL IN WIRELESS COMMUNICATION SYSTEM

(71) Applicant: LG ELECTRONICS INC., Seoul (KR)

(72) Inventors: Ikjoo JUNG, Seoul (KR); Sangrim LEE, Seoul (KR); Taehyun LEE, Seoul (KR)

(73) Assignee: LG ELECTRONICS INC., Seoul (KR)

(21) Appl. No.: 19/125,713

(22) PCT Filed: Oct. 31, 2022
(86) PCT No.: PCT/KR2022/016830

§ 371 Date: Apr. 29, 2025

(51) Int. Cl. G06N 3/0895; H04W 8/22

(52) U.S. Cl. CPC G06N 3/0895; H04W 8/22

(57) ABSTRACT

The present disclosure may provide an operating method of a first device in a wireless communication system. The first device may comprise the steps of: receiving, from a second device, a request for capability information regarding the first device; transmitting the capability information of the first device to the second device; if the first device is a device having a semantic communication capability on the basis of the capability information of the first device, receiving semantic communication-related information from the second device; generating a semantic communication signal on the basis of the semantic communication-related information; and transmitting, to the second device, the semantic communication signal and information for performing weakly labeling. Here, the semantic communication signal may be generated by using shared information and the information for performing the weakly labeling

### CROSS-REFERENCE TO RELATED APPLICATION(S)

This application is the National Stage filing under 35 U.S.C. 371 of International Application No. PCT/KR2022/016830, filed on Oct. 31, 2022, the contents of which are all incorporated by reference herein in their entirety.

### TECHNICAL FIELD

The following description relates to a wireless communication system, and to a device and method for generating a transmission and reception signal in a wireless communication system.

Specifically, a method and device for performing a downstream task based on a task-oriented operation in semantic communication may be provided. In addition, a method and device for generating a signal for performing a downstream task based on a weakly supervised contrastive learning technique may be provided.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to a device and method for generating a transmission/reception signal in a wireless communication system.

The present disclosure may provide a device and method for transmitting/receiving a signal between a semantic layer located at a source and a destination in a wireless communication system.

The present disclosure may provide a device and method for learning a method for generating a signal using weakly-supervised contrastive learning in a wireless communication system.

The present disclosure may provide a device and method for performing weakly labeling in a wireless communication system.

The present disclosure may provide a method for generating a signal for performing a downstream task of a destination in a wireless communication system.

The present disclosure may provide a device and method for updating background knowledge held by a source and a destination in a wireless communication system.

The present disclosure may provide a device and method for updating learning information for generating a signal in a wireless communication system.

The technical objectives to be achieved in the present disclosure are not limited to those mentioned above, and other technical tasks not mentioned may be considered by a person having ordinary skill in the art to which the technical configuration of the present disclosure is applied from the embodiments of the present disclosure described below.

As an example of the present disclosure, a method for operating a first device in a wireless communication system may include, receiving, from a second device, a capability information request for the first device, transmitting, to the second device, capability information of the first device, receiving, if the first device is a device having semantic communication capability based on the capability information of the first device, from the second device, semantic communication-related information, generating, based on the semantic communication-related information, a semantic communication signal, and transmitting, to the second device, the semantic communication signal and information for performing weakly labeling. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, a method for operating a second device in a wireless communication system may include: transmitting, to a first device, a capability information request; receiving, from the first device, capability information; transmitting, if the first device is a device having semantic communication capability based on the capability information of the first device, to the first device, semantic communication-related information; and receiving, from the first device, a semantic communication signal and information for performing weakly labeling generated based on the semantic communication-related information. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, the first device may include: a transceiver; and a processor coupled with the transceiver, wherein the processor may be configured to perform operations comprising: receiving, from a second device, a capability information request for the first device; transmitting, to the second device, capability information of the first device; receiving, if the first device is a device having semantic communication capability based on the capability information of the first device, from the second device, semantic communication-related information; generating, based on the semantic communication-related information, a semantic communication signal; and transmitting, to the second device, the semantic communication signal and information for performing weakly labeling. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, a second device in a wireless communication system, the second device may include: a transceiver; and a processor coupled with the transceiver, wherein the processor may be configured to perform operations comprising: transmitting, to a first device, a capability information request; receiving, from the first device, capability information; transmitting, if the first device is a device having semantic communication capability based on the capability information of the first device, to the first device, semantic communication-related information; and receiving, from the first device, a semantic communication signal and information for performing weakly labeling generated based on the semantic communication-related information. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, a first device may include at least one memory and at least one processor operably connected to the at least one memory, wherein the at least one processor, by the first device, may be configured to perform operations comprising: receiving, from a second device, a capability information request for the first device; transmitting, to the second device, capability information of the first device; receiving, if the first device is a device having semantic communication capability based on the capability information of the first device, from the second device, semantic communication-related information; generating, based on the semantic communication-related information, a semantic communication signal; and transmitting, to the second device, the semantic communication signal and information for performing weakly labeling. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, a non-transitory computer-readable storage medium storing at least one instruction, may include at least one instruction executable by a processor, wherein the at least one instruction may be configured to perform operations comprising: receiving, from a second device, a capability information request; transmitting, to the second device, capability information; receiving, if the computer-readable storage medium is a medium having semantic communication capability based on the capability information, from the second device, semantic communication-related information; generating, based on the semantic communication-related information, a semantic communication signal; and transmitting, to the second device, the semantic communication signal and information for performing weakly labeling. For example, the semantic communication signal may be generated using shared information and the information for performing the weakly labeling, and the weakly labeling may be an operation of providing a weak label to semantic data using the shared information and auxiliary information, and an update of the shared information may be performed based on an operation of a downstream task performed by the second device.

As an example of the present disclosure, the semantic communication signal may be used by the second device to perform a downstream task without being decoded into raw data used by the first device to generate representation.

As an example of the present disclosure, the capability information may be information for determining whether the first device is available to perform semantic communication, and may include a type of raw data that is available for processing by the first device and computational capability information of the first device.

As an example of the present disclosure, the semantic communication-related information may include at least one of an acquisition unit of the semantic data, information related to performing the weekly labeling, a mini-batch size, an augmentation type and an augmentation ratio, and configuration information of an encoding model, and the semantic data may be data extracted from the raw data, the information for performing the weekly labeling includes the auxiliary information, the acquisition unit, the augmentation type, and the augmentation ratio may be determined based on the shared information of the first device and the second device.

As an example of the present disclosure, may obtain the semantic data from the raw data; and may generate weekly labeled semantic data by performing the weekly labeling for the semantic data; and may generate augmentation data from the weekly labeled semantic data.

As an example of the present disclosure, the update of the shared information may be performed using a signal converted from the semantic communication signal, and the converted signal may be generated based on a data format used to perform the downstream task.

As an example of the present disclosure, the update of the shared information may be performed using a transform head, and the transform head may include at least one dense layer and at least one non-linear function.

As an example of the present disclosure, the update of the shared information may be performed using at least one of a representation used for pre-learning, a representation used for learning to perform the downstream task, and a representation used for inference.

As an example of the present disclosure, the learning for the downstream task may be generated based on a first layer of a transform head and at least one layer determined to perform the downstream task.

As an example of the present disclosure, the learning for the downstream task may include a fine-tuning operation or a transfer-learning operation.

As an example of the present disclosure, after pre-learning is completed, the fine-tuning operation may be performed for all networks including a neural network determined according to the downstream task, using weights of an encoder, weights for an additional operation, and weights for the first layer of a transform head.

As an example of the present disclosure, after pre-learning is completed, the transfer-learning operation may be performed for an multi-layer perceptron (MLP) added according to the downstream task, with weights of an encoder, weights for an additional operation, and weights for the first layer of a transform head fixed.

As an example of the present disclosure, the semantic communication signal may be transmitted on a layer for semantic communication.

The following effects may be achieved by embodiments based on the present disclosure.

According to embodiments based on the present disclosure, a method for transmitting and receiving a source and a destination signal in semantic communication may be provided.

According to embodiments based on the present disclosure, a method for transmitting and receiving a signal between semantic layers located at a source and a destination may be provided.

According to embodiments based on the present disclosure, a method for generating a signal suitable for a downstream task of a destination may be provided.

According to embodiments based on the present disclosure, a method for performing learning for signal generation by utilizing weakly supervised contrastive learning may be provided.

According to embodiments based on the present disclosure, a method for performing weakly labeling may be provided.

According to embodiments based on the present disclosure, a learning method for generating a signal suitable for a downstream task of a destination may be provided.

According to embodiments based on the present disclosure, a method for updating background knowledge possessed by a source and a destination can be provided to perform a downstream task located at a destination in a task-oriented manner.

The effects obtainable in the embodiments of the present disclosure are not limited to the effects mentioned above, and other effects not mentioned can be clearly derived and understood by a person having ordinary knowledge in the technical field to which the technical composition of the present disclosure is applied from the description of the embodiments of the present disclosure below. For example, unintended effects resulting from implementing the configuration described in the present disclosure can also be derived by a person having ordinary knowledge in the technical field from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system according to the present disclosure.

FIG. 2 shows an example of a wireless device according to the present disclosure.

FIG. 3 shows another example of a wireless device according to the present disclosure.

FIG. 4 shows an example of artificial intelligence (AI) device according to the present disclosure.

FIG. 5 shows an example of a communication model divided into three stages according to the present disclosure.

FIG. 6 shows an example of a semantic communication system according to an embodiment of the present disclosure.

FIG. 7 shows an example of contrastive learning according to an embodiment of the present disclosure.

FIG. 8 shows an example of instance identification (800) for contrastive learning according to an embodiment of the present disclosure.

FIG. 9 shows an example of augmentation data according to an embodiment of the present disclosure.

FIG. 10 shows an example of a problem that may occur when performing contrastive learning according to an embodiment of the present disclosure.

FIG. 11 shows an example of a framework for pre-learning according to an embodiment of the present disclosure.

FIG. 12 shows an example of semantic data generation according to an embodiment of the present disclosure.

FIG. 13 shows an example of weekly labeling based on discrete attributes according to an embodiment of the present disclosure.

FIG. 14 shows an example of weekly labeling based on a hierarchy level according to an embodiment of the present disclosure.

FIG. 15 shows the performance of edge perturbation according to an embodiment of the present disclosure.

FIG. 16 shows an example of an additional data conversion operation when the data modality is a graph.

FIG. 17 shows an example of additional data transformation operations when the data modality is text.

FIG. 18 shows an example of a configuration of a transform head according to an embodiment of the present disclosure.

FIG. 19 shows a graph of the results of performing weekly labeling based on discrete attributes according to an embodiment of the present disclosure.

FIG. 20 shows a graph of relationships between parameters related to weekly labeling based on hierarchical levels according to an embodiment of the present disclosure.

FIG. 21 shows an example of a framework for performing learning according to a downstream task according to an embodiment of the present disclosure.

FIG. 22 shows an example of a semantic signal generation operation procedure according to an embodiment of the present disclosure.

FIG. 23 shows an example of a signal diagram for initial setup of semantic communication according to an embodiment of the present disclosure.

FIG. 24 shows an example of an information exchange diagram of a mini-batch unit according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. However, the present disclosure is not limited to data transmission and reception between a base station and a mobile station, and may be implemented in various forms, such as data transmission and reception between mobile stations. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

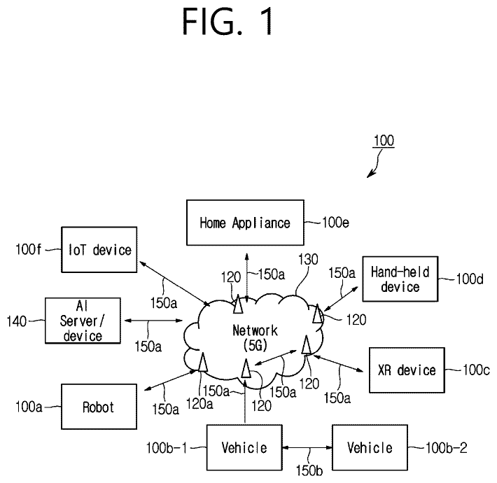

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network or a 5G (e.g., NR) network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

### Communication System Applicable to the Present Disclosure

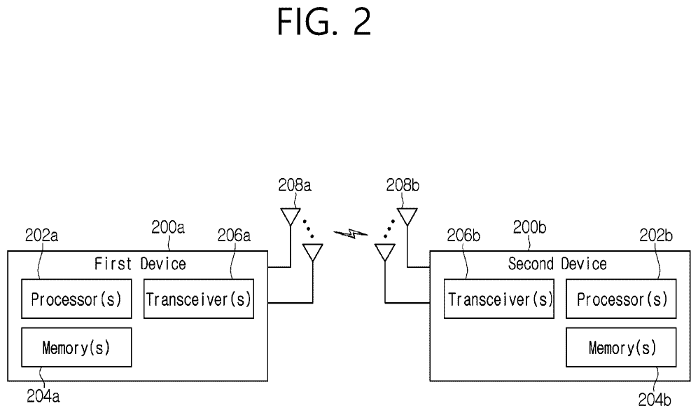

FIG. 2 shows an example of a wireless device applicable to the present disclosure.

Referring to FIG. 2, a first wireless device 200 a and a second wireless device 200 b may transmit and receive radio signals through various radio access technologies (e.g., LTE or NR). Here, (the first wireless device 200 a, the second wireless device 200 b) may correspond to (the wireless device 100 x, the base station 120) and/or (the wireless device 100 x, the wireless device 100 x) of FIG. 1.

The first wireless device 200 a may include one or more processors 202 a and one or more memories 204 a and may further include one or more transceivers 206 a and/or one or more antennas 208 a. The processor 202 a may be configured to control the memory 204 a and/or the transceiver 206 a and to implement descriptions, functions, procedures, proposals, methods and/or operational flowcharts disclosed herein. For example, the processor 202 a may process information in the memory 204 a to generate first information/signal and then transmit a radio signal including the first information/signal through the transceiver 206 a. In addition, the processor 202 a may receive a radio signal including second information/signal through the transceiver 206 a and then store information obtained from signal processing of the second information/signal in the memory 204 a. The memory 204 a may be coupled with the processor 202 a, and store a variety of information related to operation of the processor 202 a. For example, the memory 204 a may store software code including instructions for performing all or some of the processes controlled by the processor 202 a or performing the descriptions, functions, procedures, proposals, methods and/or operational flowcharts disclosed herein. Here, the processor 202 a and the memory 204 a may be part of a communication modem/circuit/chip designed to implement wireless communication technology (e.g., LTE or NR). The transceiver 206 a may be coupled with the processor 202 a to transmit and/or receive radio signals through one or more antennas 208 a. The transceiver 206 a may include a transmitter and/or a receiver. The transceiver 206 a may be used interchangeably with a radio frequency (RF) unit. In the present disclosure, the wireless device may refer to a communication modem/circuit/chip.

The second wireless device 200 b may include one or more processors 202 b and one or more memories 204 b and may further include one or more transceivers 206 b and/or one or more antennas 208 b. The processor 202 b may be configured to control the memory 204 b and/or the transceiver 206 b and to implement the descriptions, functions, procedures, proposals, methods and/or operational flowcharts disclosed herein. For example, the processor 202 b may process information in the memory 204 b to generate third information/signal and then transmit the third information/signal through the transceiver 206 b. In addition, the processor 202 b may receive a radio signal including fourth information/signal through the transceiver 206 b and then store information obtained from signal processing of the fourth information/signal in the memory 204 b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202 a and 202b. For example, one or more processors 202 a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202 a and 202b may generate one or more protocol data units (PDUs) and/or one or more service data unit (SDU) according to the descriptions, functions, procedures, proposals, methods and/or operational flowcharts disclosed herein. One or more processors 202 a and 202b may generate messages, control information, data or information according to the descriptions, functions, procedures, proposals, methods and/or operational flowcharts disclosed herein. One or more processors 202 a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202 a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202 a and 202b may be referred to as controllers, microcontrollers, microprocessors or microcomputers. One or more processors 202 a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202 a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202 a and 202b or stored in one or more memories 204a and 204b to be driven by one or more processors 202 a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202 a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202 a and 202b. In addition, one or more memories 204a and 204b may be coupled with one or more processors 202 a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202 a and 202b to transmit/receive radio signals. For example, one or more processors 202 a and 202b may perform control such that one or more transceivers 206a and 206b transmit user data, control information or radio signals to one or more other apparatuses. In addition, one or more processors 202 a and 202b may perform control such that one or more transceivers 206a and 206b receive user data, control information or radio signals from one or more addition, one or more other apparatuses. In transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202 a and 202b. One or more transceivers 206a and 206b may convert the user data, control information, radio signals/channels processed using one or more processors 202 a and 202b from baseband signals into RF band signals. To this end, one or more transceivers 206a and 206b may include (analog) oscillator and/or filters.

### Structure of Wireless Device Applicable to the Present Disclosure

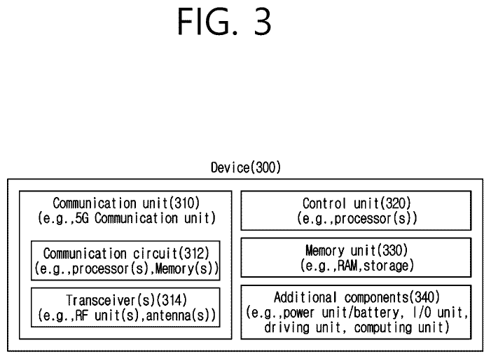

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

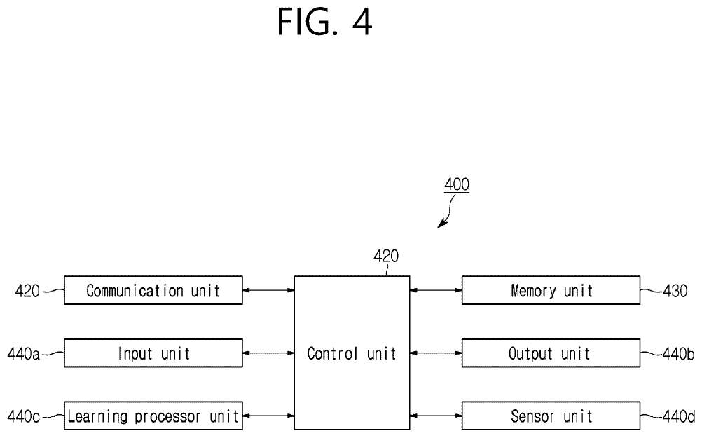

FIG. 4 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 4, the AI device 400 may include a communication unit (transceiver) 410, a control unit (controller) 420, a memory unit (memory) 430, an input/output unit 440a/440b, a leaning processor unit (learning processor) 440c and a sensor unit 440d.

The communication unit 410 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 410 may transmit information in the memory unit 430 to an external device or transfer a signal received from the external device to the memory unit 430.

The control unit 420 may determine at least one executable operation of the AI device 400 based on information determined or generated using a data analysis algorithm or a machine learning algorithm. In addition, the control unit 420 may control the components of the AI device 400 to perform the determined operation. For example, the control unit 420 may request, search for, receive or utilize the data of the learning processor unit 440c or the memory unit 430, and control the components of the AI device 400 to perform predicted operation or operation, which is determined to be desirable, of at least one executable operation. In addition, the control unit 420 may collect history information including operation of the AI device 400 or user's feedback on the operation and store the history information in the memory unit 430 or the learning processor unit 440c or transmit the history information to the AI server (FIG. 1, 140). The collected history information may be used to update a learning model.

The memory unit 430 may store data supporting various functions of the AI device 400. For example, the memory unit 430 may store data obtained from the input unit 440a, data obtained from the communication unit 410, output data of the learning processor unit 440c, and data obtained from the sensing unit 440. In addition, the memory unit 430 may store control information and/or software code necessary to operate/execute the control unit 420.

The input unit 440a may acquire various types of data from the outside of the AI device 400. For example, the input unit 440a may acquire learning data for model learning, input data, to which the learning model will be applied, etc. The input unit 440a may include a camera, a microphone and/or a user input unit. The output unit 440b may generate video, audio or tactile output. The output unit 440b may include a display, a speaker and/or a haptic module. The sensing unit 440 may obtain at least one of internal information of the AI device 400, the surrounding environment information of the AI device 400 and user information using various sensors. The sensing unit 440 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 440c may train a model composed of an artificial neural network using training data. The learning processor unit 440c may perform AI processing along with the learning processor unit of the AI server (FIG. 1, 140). The learning processor unit 440c may process information received from an external device through the communication unit 410 and/or information stored in the memory unit 430. In addition, the output value of the learning processor unit 440c may be transmitted to the external device through the communication unit 410 and/or stored in the memory unit 430.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimate and channel tracking and may be used for power allocation, interference cancellation, etc. in the physical layer of DL. In addition, machine learning may be used for antenna selection, power control, symbol detection, etc. in the MIMO system.

However, application of a DNN for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

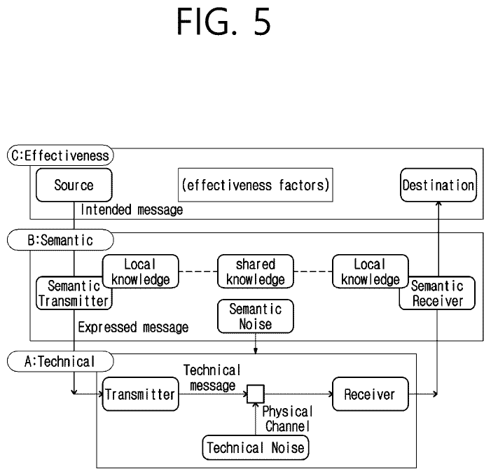

Shannon and Weaver divide communication into three stages. Stage 1 is a technical aspect, which is the issue of whether symbols for communication are transmitted accurately. Stage 2 is a semantic aspect, which is the issue of how accurately the transmitted symbols transfer the correct meaning. Stage 3 is an effectiveness aspect, which is the issue of how effectively the received meaning affects the correct operation. FIG. 5 shows an example of a communication model divided into three stages.

One of the various goals of 6G communication is to provide services that can interconnect humans and machines. As one of the next-generation wireless communication paradigms for this purpose, semantic communication based on the concept of “meaning transfer” has emerged. Existing communication focuses on communication by having a receiver (e.g., destination) decode an encoded signal received from a transmitter (e.g., source) into an existing signal without error. For example, semantic communication focuses on the meaning that is intended to be transferred through the signal, such as people exchanging information through the “meaning” of words when communicating.

The core of semantic communication is to extract “meaning” of information transmitted from a transmitter. The semantic information may be successfully “interpreted” at a receiver based on the consistent knowledge base (KB) between the source and the destination. Therefore, if operation is performed according to the meaning intended to be transferred through the signal even if there is an error in the signal, correct communication is performed. Therefore, in semantic communication, it is necessary to access whether a downstream task located at a destination is performed according to the intention included in the signal transmitted from a source (e.g., representation). In addition, when the destination performs an inference operation using the signal transmitted from the source, the destination interprets the meaning transferred by the source (e.g., the purpose of the downstream task) based on the destination's background knowledge. Therefore, in order for the destination to perform the operation according to the meaning transferred by the source based on the result obtained through reasoning using the signal transmitted from the source, the background knowledge included in the signal transmitted from the source must be able to be updated in the background knowledge of the destination. To this end, the transmitted signal must be generated considering the downstream task located at the destination. Such a task-oriented semantic communication system may provide the advantage of preserving task-relevant information while introducing useful invariance to downstream tasks.

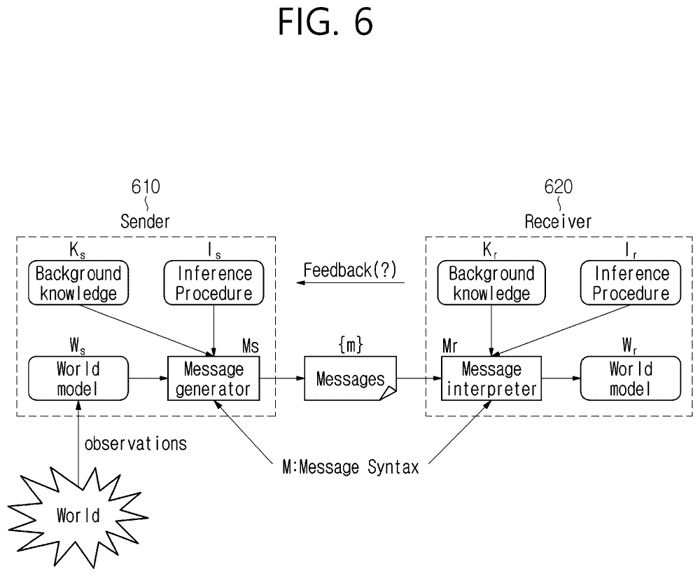

FIG. 6 shows an example of a semantic communication system according to an embodiment of the present disclosure.

Referring to FIG. 6, operations for semantic communication of a transmitter (610) and a receiver (620) may be confirmed. Shannon entropy H(W) of world model W may be expressed as in the following Equation 1. Shannon entropy may be a model entropy of a semantic source.

H(W)=−Σ_{w∈W}μ(w)log₂μ(w) [Equation 1]

World model Wₛ is a set of interpretations, which is a probability distribution μ, and μ(W) is a model distribution. At this time, if Wₓ is a set of its models Wₛ for which x is true, A logical probability m(x) of message x may be expressed as in the following Equation 2.

$$m ( x ) = \frac{μ ( {W}_{x} )}{μ ( W )} = \frac{{\sum }_{w ∈ W , w \vert = x} μ ( w )}{{\sum }_{w ∈ W} μ ( w )} \qquad [ Equation 2 ]$$

Semantic entropy Hₛ(x) of message x may be expressed as shown in the following Equation 3.

Hₛ(x)=−log₂(m(x)) [Equation 3]

At this time, when background knowledge k is considered, the set of possible worlds of Equation 2 and Equation 3 may be restricted to sets compatible with k. Therefore, it may be expressed as conditional logical probability as in Equation 4 and Equation 5 below.

$$m ( x \vert K ) = \frac{μ ( {W}_{x} )}{μ ( W )} = \frac{{\sum }_{w ∈ W , w \vert = K} μ ( w )}{{\sum }_{w ∈ W , w \vert = K} μ ( w )} \qquad [ Equation 4 ]$$

$${H}_{s} ( x \vert K ) = - {log}_{2} ( m ( x \vert K ) ) \qquad [ Equation 5 ]$$

As an example, Table 2 below shows a truth table where p is a statistical probability and k is background knowledge. Specifically, Table 2 is an example of a truth table where p(A)=p(B)=0.5 and K={A->B}.

TABLE 2

| # | A | B | A → B | probability |
|---|---|---|---|---|
| 1 | 0 | 0 | 1 | 0.25 |
| 2 | 0 | 1 | 1 | 0.25 |
| 3 | 1 | 0 | 0 | 0.25 |
| 4 | 1 | 1 | 1 | 0.25 |

According to Table 2, the possible worlds may be reduced to a series of truth assignments (e.g., cases 1, 2, and 4 in Table 1) where A->B is true. Accordingly, conditional logical probabilities such as those in Equations 6, 7, and 8 below may be obtained.

m(A|K)=1/3 [Equation 6]

m(B|K)=2/3 [Equation 7]

m(A∧B)=1/3 [Equation 8]

Logical probabilities are different from a priori statistical probabilities because they are based on background knowledge, and in the new distribution, A and B are no longer logically independent (as m(A|K)m(B|K)≠m(A∧B|K).).

For example, the new distribution μ′ of the model set in the case where background knowledge k exists may be expressed as in the following Equations 9 and 10.

$${μ}^{′} = \frac{μ ( w )}{{\sum }_{v ∈ W , v \vert = K} μ ( v )} \qquad [ Equation 9 ]$$

$$H ( W \vert K ) = {\sum }_{w ∈ W , w \vert = K} {μ}^{′} ( w ) {log}_{2} ( {μ}^{′} ( w ) ) \qquad [ Equation 10 ]$$

The following Equation 11 represents the entropy of the source without considering background knowledge, and the following Equation 12 represents the model entropy of the source considering background knowledge.

H(W)=−4*0.25 log₂(0.25)=2 [Equation 11]

H(W|K)=−3*1/3 log₂(⅓)=1.585 [Equation 12]

As in Equation 11 and Equation 12, a source may compress a message it wants to transfer without missing information through shared background knowledge. For example, the source and a destination may transmit and receive the maximum amount of information with a small data capacity through the shared background knowledge. One of the main reasons why communication at the semantic level can improve performance compared to the existing technical level is because background knowledge is taken into account. Therefore, in the present disclosure, a method is proposed to generate and transmit/receive a signal by considering background knowledge suitable for a downstream task located at a destination, for performing semantic communication.

According to an embodiment of the present disclosure, a new layer, a semantic layer, which manages overall operations for semantic data and messages may be added. The semantic layer is a layer for a task-oriented semantic communication system, and may be used for signal generation and transmission/reception between a source and a destination. In order to perform communication through the semantic layer, a protocol, which is a convention between layers, and a definition of a series of operation processes may be required, which are described below.

For example, in an actual communication environment, most of the raw data held or collected by a source is unlabeled data (hereinafter referred to as ‘unlabeled data’). In this case, performing labeling on unlabeled data may incur additional costs. Therefore, contrastive learning, which is an artificial intelligence/machine learning (AI/ML) technology, may be used as a technology that can perform communication using the unlabeled data itself. Below, contrast learning, a technology that can be applied to a semantic system, is described. As an example, contrast learning may be introduced to a semantic layer for performing semantic communication.

Contrastive learning is a method of learning the correlation of data through a representation space. Specifically, through contrastive learning, high-dimensional data may be changed into low-dimensional data (e.g., dimension reduction) and positioned in the representation space. Then, the similarity between data may be measured based on the location information of each data positioned in the representation space. For example, a semantic communication system may learn to a position positive pairs of representations close to each other and negative pairs of representations far from each other through contrastive learning. A positive pair is a pair of similar data, and a negative pair is a pair of dissimilar data. Contrastive learning may be applied to both supervised learning and unsupervised learning, but the contrastive learning may be used particularly usefully when learning is performed using unsupervised data without labeled data. Therefore, contrastive learning is suitable for building task-oriented semantic communication systems in real-world environments where unlabeled data dominates the majority.

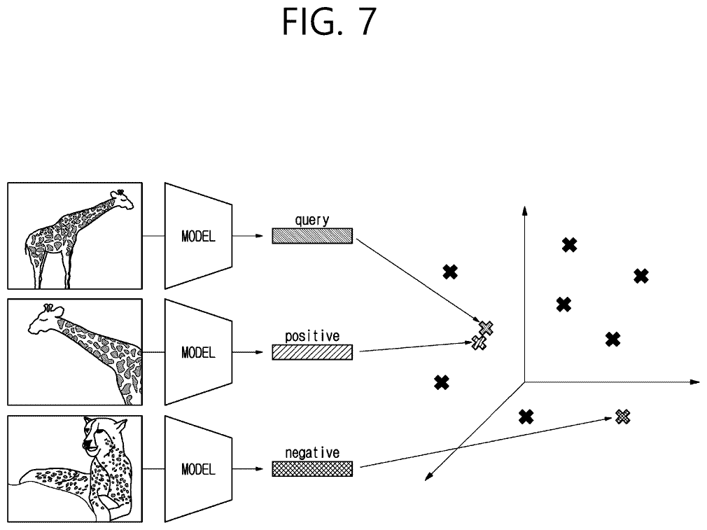

FIG. 7 shows an example of contrastive learning according to an embodiment of the present disclosure.

For example, FIG. 7 shows a case where contrastive learning is performed based on a giraffe image. However, this is only an example for the convenience of explanation and may not be limited to the above-described embodiment. Referring to FIG. 7, a contrastive learning operation performed when a target task is a classification task and a data modality is an image may be confirmed. A query that serves as a reference for performing a classification task on image data is a giraffe image. Representations of giraffe images may be learned to be located close to the representation of the query, and representations for images other than giraffe images may be learned to be located far from the representation of the query. For example, the contrastive learning technique trains an encoder so that data similar to the reference data is mapped close to the reference data, and data dissimilar to the reference data is mapped far away.

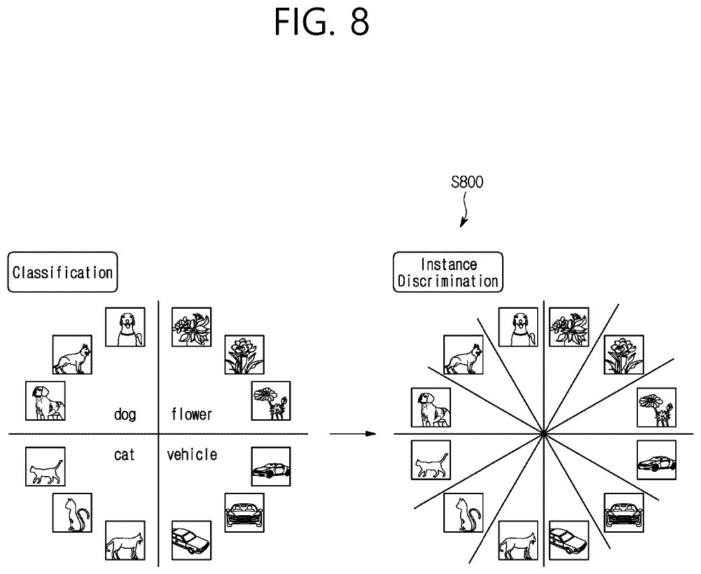

FIG. 8 shows an example of instance identification (800) for contrastive learning according to an embodiment of the present disclosure. A model performing contrastive learning may learn data through instance discrimination (800).

An instance refers to each data sample being trained. For example, an instance may be a sample of image data of a specific size, or a text data sample in sentence units. Instance identification is to classify data by determining all instances included in the entire data set as each class. Therefore, if there are N instances, N identification tasks may be performed. Since instance identification learns the difference between instances based on the similarity between instances, it provides an advantage of obtaining useful representations for data without label information. If a downstream task is performed using the representation learned through instance identification, the performance of the model can be improved as if a supervised learning method was performed.

For example, instance identification has a large increase in the identification workload as the number of data samples increases. For example, if there are 10 million data samples, 10 million identification tasks may be performed. Therefore, as the number of data samples increases, the denominator for softmax calculation for probability calculation increases, and the probability value decreases, which may make learning difficult. To solve this problem, noise-constrative extimation (NCE) may be used as an appropriate approximation calculation method. The multi-class classification operation may be changed to a binary classification operation that determines whether it is a data sample or a noise sample through NCE.

In order to perform NCE, it is necessary to define a comparison method to determine whether a random sample is a similar sample (positive sample) (hereinafter referred to as ‘positive sample’) or a dissimilar sample (negative sample) (hereinafter referred to as ‘negative sample’) with respect to a reference sample. One method for generating a positive sample is data augmentation (hereinafter referred to as ‘augmentation’). Augmentation is to generate new data by modifying existing data. From a semantic point of view, the augmented data (hereinafter referred to as ‘augmentation data’) includes the same meaning that the existing data intends to transfer. That is, the information included in the existing data and the augmentation data is the same. Therefore, the representations of each of the original data and augmentation data should be similar. Therefore, the existing image and the augmentation data may be defined as positive samples, and anything that is not a positive sample may be defined as a negative sample.

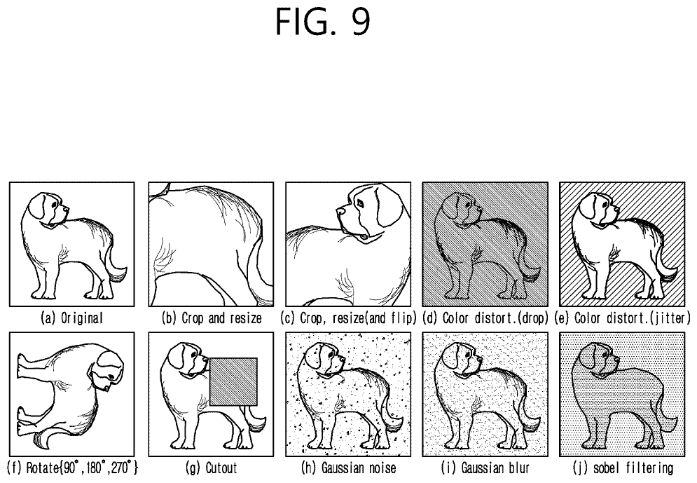

FIG. 9 shows an example of augmentation data according to an embodiment of the present disclosure.

Referring to FIG. 9, the result of performing augmentation on a dog image may be confirmed. For example, data may be augmented through a method of cropping a portion of image data, a method of adjusting the size, a method of flipping, a method of changing the color, a method of rotating, etc.

For contrastive learning, the NCE loss function of Equation 13 may be used.

$$ℒ = {𝔼}_{x , {x}^{+} , {x}^{-}} [ - log ( \frac{{e}^{{f ( x )}^{T} f ( {x}^{+} )}}{{e}^{{f ( x )}^{T} f ( {x}^{+} )} + {e}^{{f ( x )}^{T} f ( {x}^{-} )}} ) ] \qquad [ Equation 13 ]$$

In Equation 13, x is the reference data (query data), x⁺ is data related to the data or data similar to x, and x⁻ is data unrelated to the reference data or data not similar to x.

As described above, the contrastive learning technique provides the advantage of learning useful representations from the unlabeled data itself. Therefore, the contrastive learning technique may be applied to semantic communication as an AI/ML technology of an encoder that performs semantic source coding. In addition, the background knowledge of the source and destination should be appropriately utilized so that representations based on the embedding space may be generated from the data. In addition, information for the positive samples and negative samples that the model learns needs to be updated in the background knowledge of the source and the background knowledge of the destination. For example, contrastive learning may have the following problems.

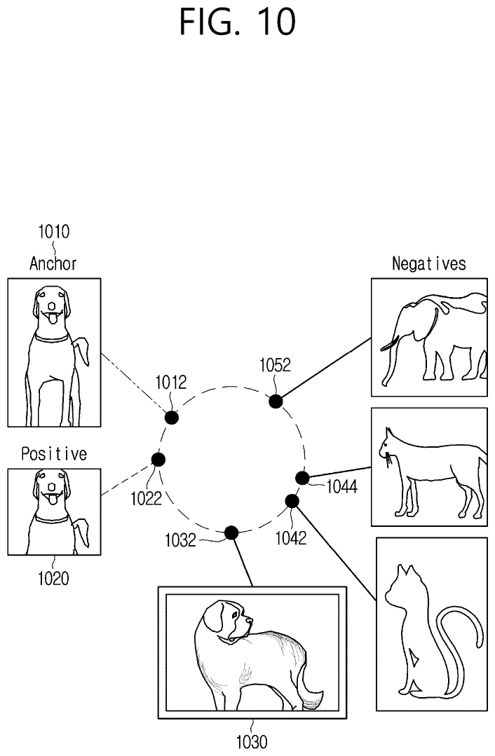

Referring to FIG. 10, when the target task is a classification task performed based on dog images and the data modality of the input is an image, and contrastive learning is performed, a class collision problem that may occur may be confirmed. If the classification task is successfully performed after contrastive learning is performed, the representations of the dog images (1012, 1022, 1032) should be located close to each other, and the representations of the images of objects other than dogs (1042, 1044, 1052) should be located far from the representations of the dog images (1012, 1022, 1032). However, as shown in FIG. 10, it may be confirmed that the representation (1022) of a positive sample (1020) generated by performing augmentation on an anchor image (1010) is located close to the representation (1012) of the anchor image, whereas the representation (1032) of another sample (1030), which is a dog image but is not identical to the anchor image (1010), is located far from the representation (1012) of the anchor. For example, even though the other sample (1030), which is a dog image, should be classified with the same label as the anchor image (1010), the other sample (1030), which is a dog image, is classified as a negative sample and is located far from the representations of the dog images. Accordingly, when contrastive learning is utilized during learning, a problem may arise in which the output according to the downstream task operation located at the destination is different from the result intended by the source. In addition, there is a problem that contrastive learning performs incorrect learning by ignoring the label and learning the data even if the data has the correct label information that is to be obtained through the downstream task operation. Therefore, in order to ensure the accuracy of learning, it is necessary to perform contrastive learning by considering the label of the data if it exists.

Accordingly, in the present disclosure, a framework and related procedures of a semantic communication system utilizing weakly-supervised contrastive learning are proposed. Through this, problems that may occur when performing contrastive learning can be supplemented, and a source can learn representations using acquired data and transmit them to a destination, and the destination can perform downstream tasks as intended by the source without restoring the received representations.

According to the present disclosure, for example, if auxiliary information (e.g., data attributes, hashtags for images on Instagram, metadata such as personal identity and nationality, text descriptions for images, etc.) exists in the data, the representation learning performance of the source and the operation performance of the downstream task located at the destination can be improved by performing contrastive learning using the auxiliary information.

For example, as the representation learning performance of the source is improved and the generated semantic representation is updated with the background knowledge of the source and the background knowledge of the destination, the reasoning performance using the background knowledge can also be improved.

The framework proposed in this disclosure may include a pre-training operation for semantic source coding, and a training operation for a downstream task of a destination. Here, semantic source coding is an operation in which a source generates a signal (e.g., a representation) to be transmitted to a destination. Through this disclosure, transmission and reception signals may be generated by considering a downstream task to be performed at the destination, and the downstream task may be performed as intended by the source. At this time, the source and the destination may share background knowledge. When the pre-training and the training for the downstream task are completed, inference may be performed.

For example, the present disclosure may be applied to a signal transmission and reception protocol using a semantic layer that may be newly added in a task-oriented semantic communication system, but is not limited thereto, and may be applied to a framework and related procedures for task-oriented semantic communication using contrastive learning.

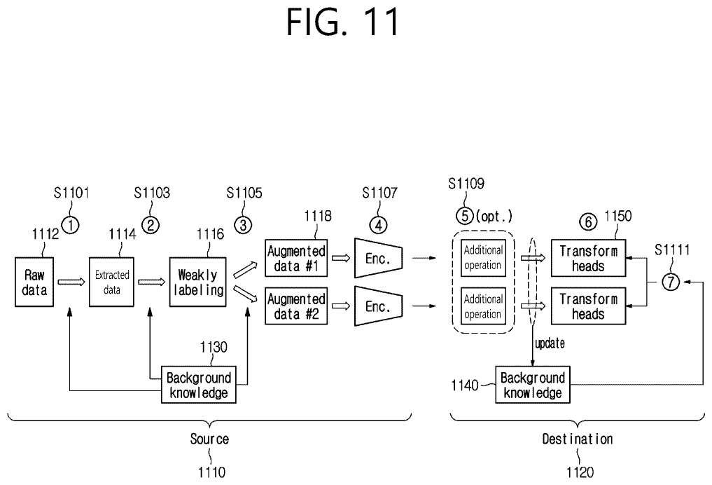

FIG. 11 shows an example of a framework for pre-learning according to an embodiment of the present disclosure. The framework for pre-learning may be composed of operations of a source (1110) and a destination (1120). At this time, a transform head (1150) may be used as one of the encoding models. Steps S1101 to S1107 described below are operations performed at the source, and steps S1109 and S1111 are operations performed at the destination. Here, pre-learning may be performed in units of mini-batch.

Referring to FIG. 11, in step S1101, the source (1110) may obtain semantic data (1114) from raw data (1112). The semantic data (1114) is data extracted from the raw data (1112). The semantic data (1114) may be used to create a message (e.g., expression) that includes ‘meaning’ information that the source (1110) wants to convey to the destination (1120). At this time, the acquisition unit of the semantic data (1114) may be determined using background knowledge (1130, 1140) possessed by the source (1110) and the destination (1120).

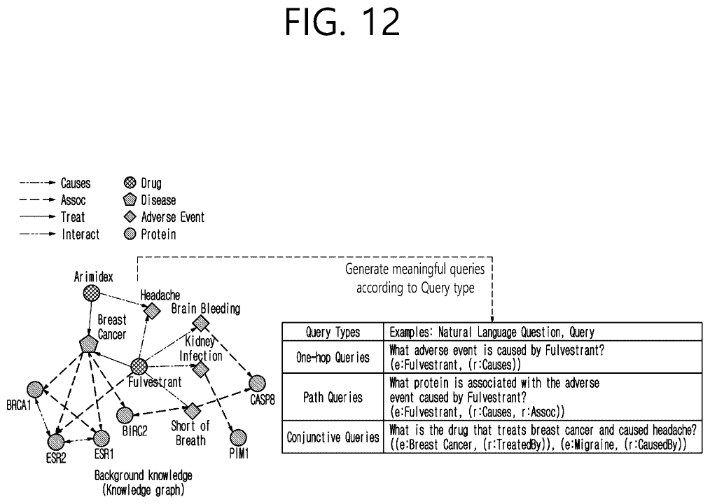

For example, if the background knowledge includes a biopharmaceutical knowledge graph as in FIG. 12, and the source acquires semantic data in a query format from raw data, semantic data acquisition units such as ‘queries related to the corresponding biopharmaceutical field,’ ‘types of corresponding queries,’ and ‘length of queries,’ may be determined based on the biopharmaceutical knowledge graph. For example, if the source acquires semantic data in a text format from raw data, semantic data acquisition units such as whether to transmit data in sentence units or paragraph units may be configured based on background knowledge related to text data.

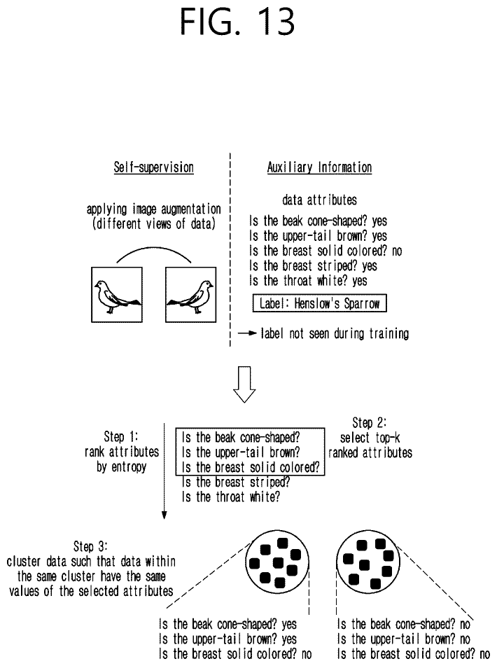

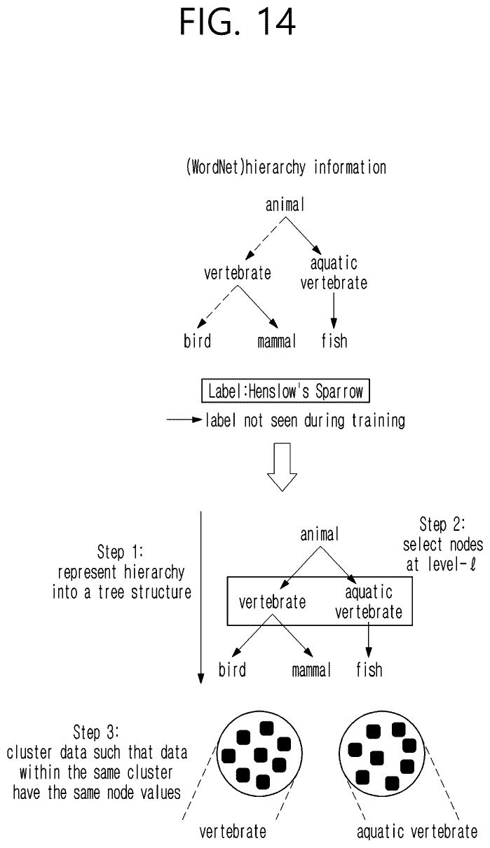

In step S1103, the source (1110) may perform weak labeling on the semantic data (1114). The weekly labeling may be an operation of performing a classification task on the data using auxiliary information. For example, when the weekly labeling is performed, a weak label may be assigned to the data. For example, if auxiliary information exists in the raw data or the background knowledge data constructed based on the raw data, the source (1110) may perform weak labeling on the semantic data (1114) using the auxiliary information. At this time, information included in the background knowledge may be utilized. The method of performing the weekly labeling is described in detail in FIG. 13 and FIG. 14 below. Although the weekly labeling may have noise compared to general labeling, it has the advantage of being very low cost compared to a human performing annotation work.

FIG. 13 and FIG. 14 show examples of weekly labeling based on auxiliary information according to an embodiment of the present disclosure.

According to an embodiment, the auxiliary information may be a discrete attribute of the data (hereinafter, ‘discrete attribute’). For example, discrete attributes may be selected as auxiliary information used to perform weekly labeling. For example, a binary indicator, which is an example of a discrete attribute such as ‘short/long hair’ and ‘short sleeves/long sleeves’ for a human image, may be used as auxiliary information.

FIG. 13 shows an example of weekly labeling based on data attributes according to an embodiment of the present disclosure. Referring to FIG. 13, a weekly labeling process performed when a data modality is an image may be confirmed. The types of data attributes may be diverse, and the number of data attributes handled by the source and destination may be determined through initial configurations. First, the source may measure the entropy of data attributes to determine the ranking. Then, the source may configure an attribute set including the top k attributes with high measured entropy values. A high measured entropy value of an attribute means that the corresponding attribute is diversely distributed. In addition, the source may perform clustering on the attribute set so that attributes in the same cluster have the same result value, thereby generating a cluster. For example, the source may use auxiliary information to construct attribute sets, and may construct data included in clusters within each attribute set to have the same value. At this time, since the entropy of the attribute may change according to the background knowledge update, the entropy measurement should be performed in units of mini-batch, which is a learning unit. Information related to the generated cluster may be used to perform weekly labeling.

According to an embodiment, the auxiliary information may be data's hierarchy information (hereinafter, ‘hierarchy information’). For example, the hierarchy information may be selected as the auxiliary information used to perform weekly labeling.

FIG. 14 shows an example of weekly labeling based on data hierarchy information according to an embodiment of the present disclosure. Referring to FIG. 14, the weekly labeling operation performed when the data modality is text and the background knowledge includes WordNet may be confirmed. First, the source may form data into a tree structure according to the hierarchy based on the auxiliary information. At this time, each node of each level in the tree structure may correspond to a corresponding coarse label. Thereafter, the source may select nodes corresponding to the [symbol] th level to configure a node set. At this time, since the tree structure according to the hierarchy may be changed according to the background knowledge update, the source may select nodes corresponding to the [symbol] th level in mini-batch units, which are learning units. Then, the source may perform clustering on the node set so that data included in the same cluster have the same coarse label, thereby generating clusters. Information related to the generated cluster may be used to perform weekly labeling.

At this time, the discrete attributes and hierarchical information of the data are only examples of auxiliary information used to perform weekly labeling, and the auxiliary information may not be limited thereto. For example, other auxiliary information (e.g., asymmetric attributes, which are attributes with unequal importance) may be used for weekly labeling.

For example, when the source performs clustering based on auxiliary information, the operational performance of the downstream task located at the destination (e.g., the interpretation performance for the expression received from the source of the destination) may be determined based on the hyper-parameter values (e.g., the k value when the auxiliary information is a data attribute, or the [symbol] value when the auxiliary information is hierarchical information). Therefore, the hyper-parameter values need to be determined based on background knowledge (e.g., domain knowledge). In addition, when the background knowledge is updated, the existing hyper-parameter values may be changed due to changes in the properties of the auxiliary information (e.g., entropy of the discrete attribute of the data, changes in the tree structure according to the data hierarchical information, etc.), and therefore, the hyper-parameter values may be changed during pre-learning.

In step S1105, the source (1110) may perform augmentation on the weekly labeled semantic data (1116). The weekly labeled semantic data (1116) may be data included in a cluster generated by performing weekly labeling on the semantic data. Augmentation is a technique used to increase the overall parameters of data by transforming data to generate new data. As an example, the source (1110) may augment the weekly labeled semantic data (1116) to generate positive samples required for contrastive learning. At this time, if the acquired semantic data is N mini-batches, 2N augmentation data may be generated.

The type of augmentation may vary according to the modality of the data. Table 3 below shows examples of augmentation types when the data modality is an image.

TABLE 3

| Category | Type |
|---|---|
| Geometric | Transformation using Flipping, Cropping, Rotation, |
| Transformations | Color space, Noise Injection, etc. |
| Color space | Adjust brightness by adjusting one of the R, G, and B |
| Transformation | values to its minimum or maximum |
| Kernel Filter | Randomly mix pixels in an area of the size of N × N |
| | using Gaussian Filter, Edge Filter, Patch shuffle filter, |
| | etc. |
| Random Erasing | Generate a new image by randomly deleting specific |
| | parts of the image |
| Mixing Images | Generate a new image using parts of each of multiple |
| | images. |

Table 4 below shows an augmentation technique when the data modality is text.

TABLE 4

| Category | Sub-category | Type |
|---|---|---|
| Text | Random Noise Injection | Synonym Replace(SR), Random |
| modification | | Insertion(RI), Random Swap(RS), Random |
| | | Deletion(RD) |
| Text generation | Back-Translation | Generating artificial data from |
| | | monolingual data using a translator |
| | | Beam Search, Random Sampling, Top- |
| | | 10 Sampling, Beam + Noise |
| | Conditional Pre-training | Augmenting text using three pre-trained |
| | using pre-trained models | models (Auto-Regressive (AR), Auto- |
| | | Encoder (AE), and Sequence-to-sequence |
| | | (Seq2Seq)) |
| | | Perform fine-tuning by including label |
| | | information in the pre-trained model |
| Others | Dropout noise | Generate positive pairs with similar |
| | | embeddings by changing only the dropout |
| | | mask based on the same sentence |

Table 5 below shows an augmentation technique when the data modality is a graph.

TABLE 5

| Category | Sub-category | Type |
|---|---|---|
| Topology(structure) | Edge perturbation | Edge Removing(ER), Edge |
| augmentation | | Adding(EA), Edge Flipping(EF) |
| | Node perturbation | Node Dropping(ND) |
| | Subgraph | Subgraph induced by Random |
| | sampling(SS) | Walks(RWS) |
| | Graph Diffusion(GD) | Diffusion with Personalized |
| | | PageRank(PPR), Diffusion with |
| | | Markov Diffusion Kernels[MDK] |
| Feature augmentation | | Feature Masking[FM], Feature |
| | | Dropout[FD] |

For example, the type of augmentation applied may affect the performance of the semantic source coding of the encoder (1118). For example, if the modality of the data transmitted by the source (1110) is text and the downstream task located at the destination is to distinguish whether the sentence is positive or negative, the operation may not be performed according to the meaning that the source (1110) intends to convey due to grammatical elements of the text. Therefore, in order to preserve the meaning intended to be conveyed through the text data, the type of augmentation and the ratio of augmentation should be configured based on the background knowledge (1130).

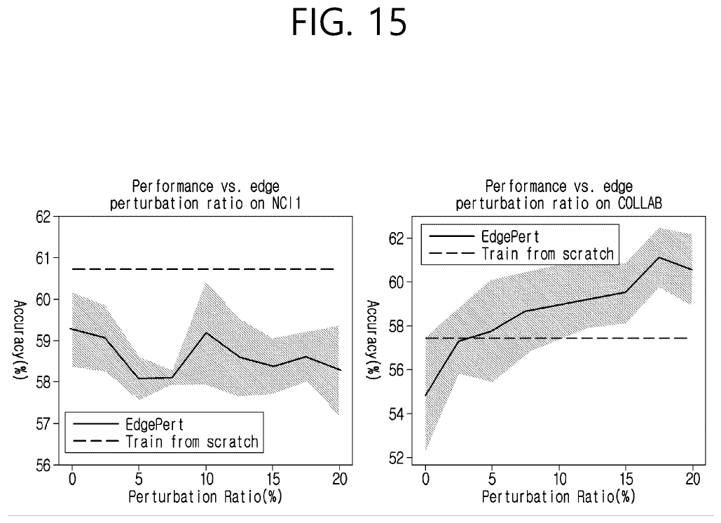

Referring to FIG. 15, it may be confirmed that the performance of edge perturbation for NCI1, which is biochemical molecules data related to chemicals, is degraded compared to COLLAB, which is social network data. This indicates that a change in an edge in biomolecule data such as NCI1 corresponds to the removal or addition of a covalent bond, and the identity and validity of the compound may be significantly changed, and the meaning that the source (1110) intends to convey to the destination (1120) may not be correctly conveyed. Therefore, in order not to perform augmentation such as edge perturbation on data such as NCI1, the source (1110) or the destination (1120) may configure the type of data augmentation using background knowledge (1130). In addition, it may be confirmed through FIG. 15 that the performance is determined according to the perturbation ratio. Therefore, the application ratio of data augmentation also needs to be configured using background knowledge (1130).

For example, the source (1110) may generate augmentation data (1118) by combining multiple augmentation techniques to improve system performance. For example, if the data modality is an image, the source (1110) may augment the data by combining all four augmentation techniques of crop, flip, color jitter, and grayscale. In addition, the source (1110) may augment the data using multiple augmentation techniques belonging to different categories. In fact, if the data modality is a graph, the performance of the system is improved when similar samples are generated using multiple augmentation techniques belonging to multiple categories, compared to applying an augmentation technique included in a single category. In addition, the combination of augmentation techniques showing the best performance is different according to the domain of the data. For example, the type and ratio of augmentation should be configured based on the background knowledge (1130) (e.g. domain knowledge) possessed according to the data modality.

In step S1107, the source (1110) may perform encoding on the weekly labeled augmentation data (1116). At this time, an appropriate encoder (1118) may be used according to the data modality. For example, if the data modality is an image, a CNN-based model (e.g., ResNet18) may be used, and if the data modality is text, a pre-trained model (e.g., BERT) may be used. For example, the encoders (1118) located in each of the dual branches may be the same. In addition, if an existing model is used as the encoder (1118), only the configuration for feature extraction among the configurations of the encoder (1118) may be used. Here, the configuration for feature extraction may be used to obtain a representation. The source (1110) may transmit the result (hereinafter referred to as ‘encoded data’) (e.g., representation) generated by performing encoding to the destination (1120). At this time, the source (1110) may transmit cluster information corresponding to a weak label together with the encoded data. Here, the encoded data may be viewed as a semantic message created using semantic data in semantic communication.

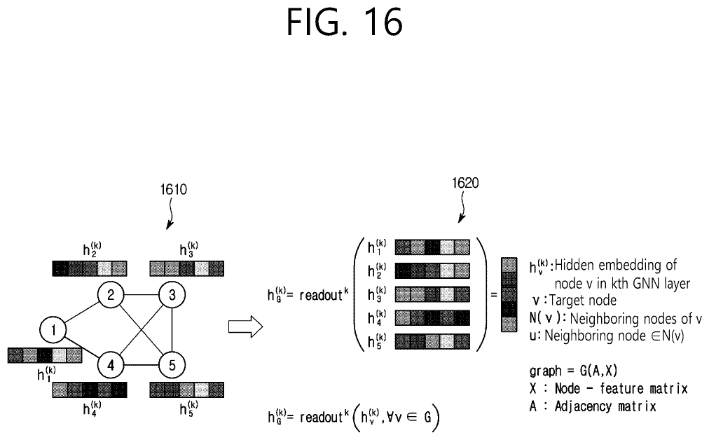

For example, in step S1109, the destination (1120) may perform an additional operation of converting the format of the encoded data according to the format of the data used to perform the downstream task. FIG. 16 shows an example of an additional data conversion operation when the data modality is a graph. Referring to FIG. 16, when encoding is performed on data, the output may be output as a node representation (1610). At this time, the destination (e.g., the destination (1120) of FIG. 11) may determine whether to perform an additional operation according to the operation method of the downstream task. If the downstream task is an operation performed using the node representation (1610), the destination may not perform the additional operation. For example, if the downstream task is an operation performed using the graph representation, the destination may perform an additional operation of converting the node representation into a graph representation. At this time, the destination may perform additional operations via the configured readout function (1620) (e.g., average, sum).

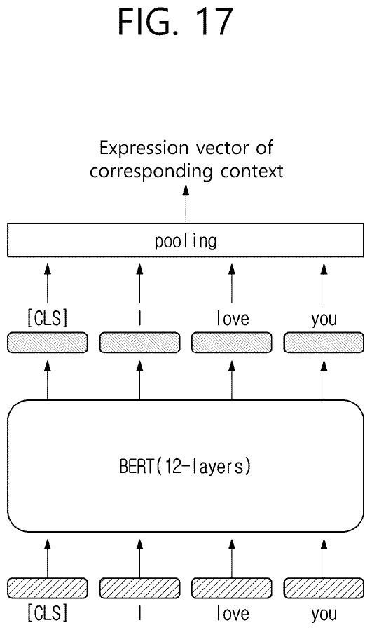

For example, FIG. 17 shows an example of additional data transformation operations when the data modality is text. Referring to FIG. 17, text data may be encoded through a pre-trained model (e.g., BERT). Then, a word vector set, which is a representation of a word unit, may be output as an encoding result. The destination may decide whether to perform an additional operation according to the operation method of the downstream task. If the downstream task is an operation performed using a word representation, the destination may not perform an additional operation. For example, if the downstream task is an operation performed using a context vector, which is a context-based representation, the destination may perform a pooling operation (e.g., mean, max) to transform the word vector into a context vector.

For example, if the data modality is an image, local feature vectors may be output from each branch as encoding results, and the destination may perform an additional operation to generate a global summary vector from one of these paths. In this case, the model may generate the global summary vector in a similar way as it used the readout function when the data modality is a graph.

As in the above embodiments, task-oriented semantic communication may be performed by additional operations performed to obtain a representation suitable for the purpose of the downstream task located at the destination. Through this, flexibility may be provided to the semantic communication system. At this time, the additional operations of step S1109 may be learned by configuring a multi-layer perceptron (MLP).

When step S1109 is completed, at step S1111, the destination (1120) may learn encoded data (e.g., representation) using a loss function. Below, a transform head (1150) used for learning is described.

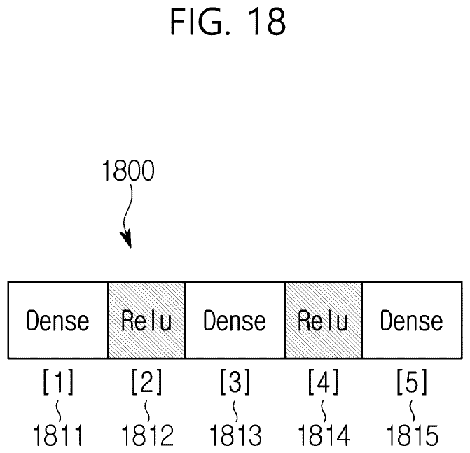

FIG. 18 shows an example of a configuration of a transform head (1800) according to an embodiment of the present disclosure. The transform head (1800) is an example of an encoder for a semantic communication system (e.g., the transform head (1150) of FIG. 10).

Referring to FIG. 18, the transform head (1800) may include at least one dense layer (1811, 1813, 1815) and at least one non-linear function corresponding to ReLu (rectified linear unit) (1812, 1814) through the projection head technique. The structure of the transform head (1800) is not limited to the structure of FIG. 18, and the number of layers and the non-linear function may vary according to the model of the encoder. The reason for configuring the transform head (1800) as shown in FIG. 18 is as follows.

The SimCLR-based model calculates the loss using a non-linear projection head. In this case, the performance is superior to that of a linear projection head or when no projection head is used. In addition, the SimCLRv2-based model performs learning by increasing the size of the encoder model and increasing the number of linear layers that constitute the projection head. This is because the lower the label fraction and the more layers there are in the projection head, the better the performance. Accordingly, the present disclosure proposes a transform head with a configuration as exemplified in FIG. 18 as an encoding model for maximizing the performance of semantic communication through effective embedding learning.

Afterwards, in step S1111, the destination (1120) may learn encoded data (e.g., representation) using a loss function. At this time, learning may be performed using CI-InfoNCE loss (clustering InfoNCE loss). CI-InfoNCE loss is an extension of Equation 13, and is a loss function that allows learning similar representations for data having the same week label (e.g., data located in the same cluster) and learning different representations for data having different week labels (e.g., data located in different clusters). Here, learning similar representations means learning to make the distance between representations close, and learning different representations means learning to make the distance between representations far. CI-InforNCE loss is as shown in Equation 14 below.

$$Cl - InfoNCE := {}_{f}^{sup} {𝔼}_{( {x}_{i} , {y}_{i} ) \sim {{𝔼}_{z \sim {P}_{Z}} [ {P}_{X \vert z} {P}_{Y \vert z} ]}^{⊗ n}} [ \frac{1}{n} {\sum }_{i = 1}^{n} log \frac{{e}^{f ( {x}_{i} , {y}_{i} )}}{\frac{1}{n} {\sum }_{j = i}^{n} {e}^{f ( {x}_{i} , {y}_{j} )}} ] \qquad [ Equation 14 ]$$

In Equation 14, variables expressed in capital letters are random variables, variables expressed in small letters are outcomes of random variables, X and Y are representations generated from weekly labeled augmentation data (e.g., the result of the encoder located at the source, the result after performing additional operations at the destination), and Z is information for clusters configured to perform weekly labeling (hereinafter referred to as ‘cluster information’). The cluster information is transmitted from the source to the destination together with the representation, which is the output of the encoder, and may be used to compute a loss function at the destination. In Equation 14, f(x, y) is any function that returns a scalar from the input (x, y), and cosine similarity may be considered for f(x, y) as in Equation 15 below.

$$f ( x , y ) = ( \frac{{g ( x )}^{T} g ( y )}{‖ g ( x ) ‖ ‖ g ( y ) ‖} ) / τ \qquad [ Equation 15 ]$$

In Equation 15, g(⋅) is a neural network located at the destination, and t is a hyper-parameter that serves as a criterion for classifying positive or negative between classes. In general, a large value of τ serves as a strict criterion for making it easier to classify between classes, while a small value of τ forms a hard positive/hard negative, making learning more difficult but helping in robust classification.

In Equation 14,

$${\{ ( {x}_{i} , {y}_{i} \}}_{i = 1}^{n}$$

is n independent copies of (x, y)~ [symbol] _{z~P}_{_{z}}[P_{X|z}P_{Y|z}]. In Equation 14, cluster z~P_{z} is sampled first, and (x,y) pairs of x~P_{X|z} and y~P_{Y|z} may be sampled. Also, (xᵢ, yᵢ) may be called a positive pair representation when xᵢ and yᵢ have the same weak label, (xᵢ, yᵢ) (i≠j) and may be called a negative pair representation when xᵢ and yᵢ have different weak labels. Since learning is performed in the form of mini-batches, positive/negative samples may be considered using the weak labels passed along with the representations in the batch.

At this time, if the weak label (e.g., cluster) Z generated in Equation 14 is configured to be the same as the instance ID, it may be a self-supervised contrastive setting that calculates the InfoNCE as Equation 13. Here, configuration of the weak label Z to be the same as the instance ID may mean that each cluster has only one instance. In addition, if the generated weak label Z is configured as the correct label to be obtained through the downstream task operation, it may be a supervised contrastive setting.

The goal of learning is to learn the representations X and Y that are delivered to the destination in order to maximize the Cl-InfoNCE of Equation 14. From an information theory perspective, maximizing the Cl-InfoNCE means learning to include weak label information (e.g., clustering information), as shown in Equation 16 below.

Cl-InfoNCE≤D_{KL}( [symbol] _{P}_{_{Z}}[P_{X|Z}P_{Y|Z}]∥P_{X}P_{Y})≤H(Z) [Equation 16]

and the equality holds only when H(Z|X)=H(Z(Z|Y)=0

In Equation 16, Z of H(Z) is the entropy of the cluster constructed for weekly labeling, and H(Z|X) and H(Z|Y) are the conditional entropy of Z given X, Y. Through Equation 16, if D_{KL}( [symbol] _{P}_{_{Z}}[P_{X|Z}P_{Y|Z}]∥P_{X}P_{Y}) is high, it is easy to know whether (x, y) are the same weekly label. When CI-InfoNCE is maximized, representations X, Y that include clustering information Z, which is weekly label information, may be generated.

As described above, through the pre-learning process, it is possible to check whether the representations are well learned to perform actions suitable for the purpose of the downstream task located at the destination, and to check the relationship between Z and the correct label (e.g., the downstream label expressed as T) to be obtained through the downstream task action for cross validation. Mutual information I(Z;T) measures the relevance of the cluster information and the label, which is the weak label, and conditional entropy H(Z|T) measures the amount of redundant information that is not related to the downstream label in the cluster. For example, when there is high mutual information and low conditional entropy between the weak label and the downstream label using auxiliary information, improved performance of the downstream task may be expected based on the learned representation.

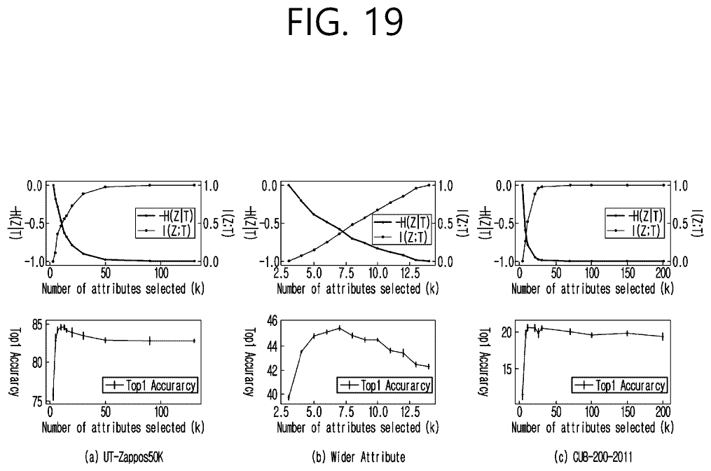

Referring to FIG. 19 in relation to performing weekly labeling using auxiliary information, it may be seen that as k increases, the mutual information I(Z;T) increases, but the conditional entropy H(Z|T) also increases. This means that as more attributes are considered, clusters that are weekly labels with more correlation with downstream labels are created, but more information that is not related to downstream may be included. This may be confirmed by the fact that when examining the Top-1 Accuracy in FIG. 19, the performance increases and then decreases as the number of selected attributes (k) increases. Therefore, for weekly labeling, it is necessary to select attributes that are judged to be the most beneficial (e.g., attributes with high entropy). Also, as shown in FIG. 19, it may be confirmed that weekly labeling performs best at the intersection of I(Z;T) and −H(Z|T).

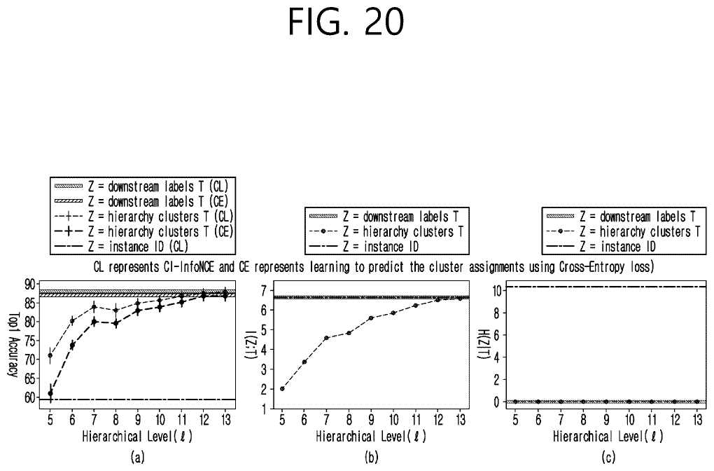

When performing weekly labeling using the hierarchical level of Wordnet data, referring to FIG. 20, it may be confirmed that performance is improved when the hierarchical level I(Z; T) is increased in FIG. 20(a), and it may be confirmed that mutual information between the weekly label cluster Z and the downstream label T increases in FIG. 20(b). In addition, referring to FIG. 20(c), it may be confirmed that H(Z|T) is maintained as 0 because the course level (e.g., intermediate node) is determined by the downstream labels (e.g., leaf nodes in the tree structure) in the tree hierarchy structure. At this time, when the generated weekly label (e.g., cluster) Z is configured to be the same as the instance ID, it may be confirmed that I(Z; T) is high, but H(Z|T) is also high. This means that the performance of self-supervised contrastive learning is reduced. Therefore, as seen in FIG. 19 and FIG. 20, when using a clustering-based representation learning method for weekly labeling, I(Z;T) and H(Z|T) should be considered.

In addition, since the label T, which is the correct answer to be obtained through the downstream task operation, is information that only the destination may know, the source may transmit information for Z to the destination, and the destination that received information for Z may calculate mutual information and conditional entropy. Accordingly, according to the type of auxiliary information in the source, a process may be required to select parameters such as k related to the selection of the top k attributes or the hierarchical level [symbol] of the data and transmit them from the destination to the source.

For example, the method of generating negative samples used for learning has a great impact on learning performance. Hard negatives are samples that are similar data but are predicted as dissimilar data. The more the destination learns the hard negative samples extracted using background knowledge together with the transmitted samples, the better the performance of the semantic communication system can be.

In addition, the destination may use the weak label information (e.g., cluster information) as well as the representation information for the data delivered from the source to update the background knowledge, and perform reasoning using the background knowledge in relation to the downstream task operation. Since the source delivers the representation and weak label information to the destination, the destination may determine a sample having the same weak label as a positive sample determined through a path (e.g., the path in FIG. 11) as a positive sample in the process of determining the samples as negative samples or positive samples. Accordingly, since the number of samples determined as positive samples increases, the number of samples determined as negative samples may decrease. Table 6 below shows the top-1 accuracy according to the number of positive samples when there are 13 samples when the batch size is 6144 and the epoch is 350. As can be seen in Table 6 below, when the number of positive samples is increased, there is an advantage in top-1 accuracy. In Table 6, when the number of positive samples is 1, it is a self-supervised approach in which the positive sample is an augmented version of the same sample.

TABLE 6

| 1 | 3 | 5 | 7 | 9 | No cap(13) |
|---|---|---|---|---|---|
| 69.3 | 76.6 | 78.0 | 78.4 | 78.3 | 78.5 |

For example, the source and destination may update the background knowledge by reflecting the background knowledge that has positive/negative samples and weak labels (e.g., cluster information). In this way, the source and destination may share the background knowledge by reflecting the background knowledge contained in the data transmitted from the source to the destination into the background knowledge of the destination.

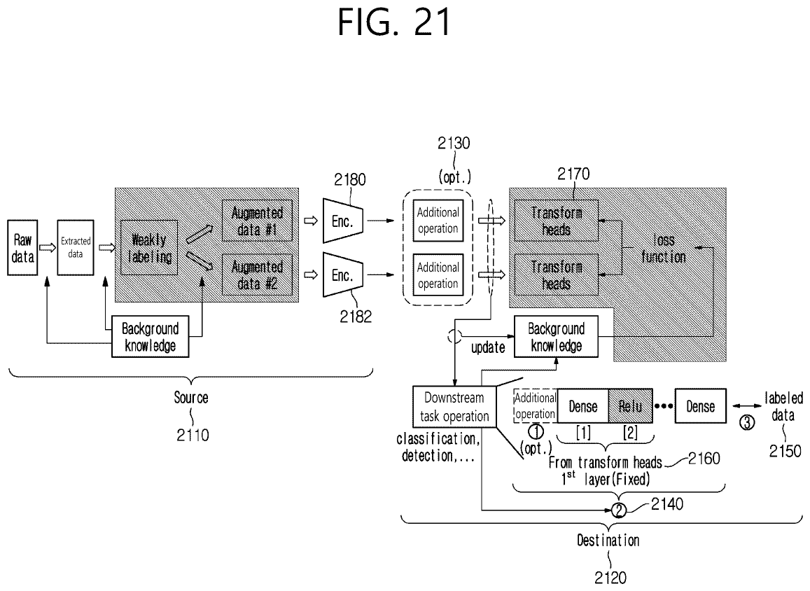

When the pre-learning as seen in FIG. 11 is completed, learning may be performed to perform a downstream task at the destination, and when learning is completed, inference may be performed. At this time, it is assumed that the source and destination have some labeled data. FIG. 21 shows an example of a framework for performing learning according to a downstream task according to an embodiment of the present disclosure. The shaded portion in FIG. 21 may not be used when performing learning and inference operations according to the downstream task.

Referring to FIG. 21, the destination (2120) performs learning for the operation of the downstream task located at the destination (2120) (hereinafter, ‘learning for the downstream task’). For example, the destination (2120) may determine layers (2140) used to perform learning for the downstream task (hereinafter, ‘downstream task learning layers’). The downstream task learning layers (2140) may include the first layer (2160) of the transform head ((e.g., the transform head (1150) of FIG. 11, the transform head (2170) of FIG. 21) used in the pre-learning (e.g., the pre-learning operation of FIG. 11)) and additional linear layers suitable for the purpose of the downstream task.

For example, according to the number of paths used in learning for the downstream task, one or two encoding results (2180, 2182) may be transmitted to the destination (2120). If two encoding results (2180, 2182) are transmitted to the destination (2120), the following additional operation (2130) may be performed.

For example, if both encoding results (2180, 2182) performed in two passes are used for learning for a downstream task, the source (2110) may transmit the two encoding results (2180, 2182) to the destination (2120) using both passes. The destination (2120) that receives the two encoding results (2180, 2182) may perform an operation to convert the two encoding results (2180, 2182) into one result through an additional operation (2130). At this time, one of various functions such as sum, average, and concatenation may be used. The operation may be learned through a neural network. For example, if only one pass is used for learning for a downstream task, the source (2110) may select only one pass and transmit one encoding result (2180 or 2182) to the destination. In this case, the destination (2120) may not perform any additional actions (2130).

Once the downstream task learning layers are determined, the destination (2120) may learn the representation received from the source (2110) using the downstream task learning layers (2140). At this time, the destination (2120) may reason the output that matches the intention delivered by the source (2110) by utilizing the background knowledge of the destination (2120) updated in the pre-learning process.

For example, the destination (2120) of FIG. 21 may perform learning using a loss function. The destination (2120) may perform learning using the labeled data (2150) it has and the outputs output from the downstream task learning layers (2140). For example, learning may be performed using cross entropy loss. At this time, cross entropy loss is only one example of a loss function used for learning, and is not limited thereto, and other loss functions (e.g., cosine similarity loss, hinge loss, etc.) may be used for learning. Learning using a loss function may be performed according to the purpose of the downstream task located at the destination.

According to an embodiment, when the destination (2120) performs fine-tuning after the pre-learning is completed, the destination (2120) may perform learning for all networks including a neural network composed of downstream task learning layers (2140) by using the weights of the encoder (2180, 2182) located in the source (2110), the weights for additional operations of the destination (2120), and the weights corresponding to the first layer of the transform head (2170).

According to an embodiment, when the destination (2120) performs transfer learning after the pre-learning is completed, the destination (2120) may fix the weights of the encoder (2180, 2182) located in the source (2110) and the weights for the additional operation of the destination (2120) and the weights corresponding to the first layer of the transform head (2170), and perform learning on the added neural network suitable for the purpose of the downstream task.

At this time, fixing the weights of the encoder (2180, 2182), the weights for the additional operation of the destination (2120), and the weights corresponding to the first layer of the transform head (2170) may mean that the feature extractor is fixed. If the downstream task learning layers (2140) include only simple linear layers except for the part where the weights are fixed, the performance of the feature extractor needs to be increased in order to improve performance through learning, so the performance of the feature extractor may be confirmed.

In this way, learning for downstream tasks may be performed by learning related networks according to the purpose of the downstream task. For example, when pre-learning and learning for downstream tasks are completed in the semantic communication system, inference may be performed on the entire network where all learning is completed. Here, inference may mean an operation in which the destination (2120) infers the intention conveyed by the source (2110) in task-oriented semantic communication. Therefore, the output output through the downstream task learning layers (2140) of FIG. 21 may be viewed as a result of performing inference. The semantic expression conveyed from the source (2310) for training and inference operations for performing downstream tasks may be updated to the background knowledge of the source (2310) and the destination (2320).

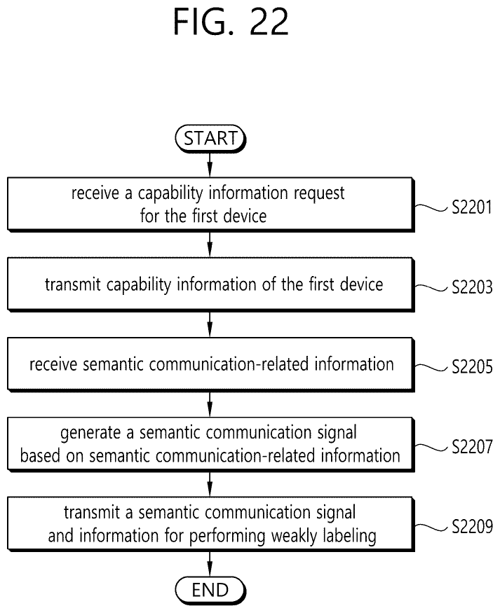

FIG. 22 shows an example of a semantic signal generation operation procedure according to an embodiment of the present disclosure.

Referring to FIG. 22, In step S2201, the first device may receive, from a second device, a capability information request for the first device. In step S2203, the first device may transmit, to the second device, capability information of the first device. Here, the capability information is used to determine whether the first device may perform semantic communication. For example, the capability information may include the type of raw data that the first device may collect, generate, or process and the computational capability information of the first device.

In step S2205, if it is determined that the first device has semantic communication capability based on the capability information of the first device, the first device may receive, from the second device, semantic communication-related information. The semantic communication-related information may be used to generate a semantic communication signal by performing semantic source coding. The semantic communication signal may be a representation that includes a meaning that the first device intends to convey to the second device. The semantic communication signal may be used for performing a downstream task without being restored (decoded) into raw data used by the first device to generate the representation by the second device. The semantic communication signal may be used to update shared information (e.g., background knowledge) held by the first device and the second device.

For example, the semantic communication signal may include at least one of a representation used for pre-training for semantic source coding, a representation used for training for performing a downstream task, and a representation used for inference. The pre-training and the training and inference for the downstream task may be performed by the first device and the second device. For example, the semantic communication-related information may include at least one of a unit of data to be acquired from raw data, information for performing weekly labeling, a mini-batch size, an augmentation type and ratio determined based on background knowledge, and information for an encoding model. In the future, the semantic communication-related information may be updated based on updated shared information using the representation used for pre-training for semantic source coding, the representation used for training for performing a downstream task, and the representation used for inference. For example, information for performing weekly labeling may include at least one of auxiliary information, whether to use auxiliary information, a type of auxiliary information, a method for performing labeling based on the auxiliary information, and a weekly label.

In step S2207, the first device may generate, based on the semantic communication-related information, a semantic communication signal. In step S2209, the first device may transmit, to the second device, the semantic communication signal and information for performing weakly labeling. The second device may perform a downstream task without a procedure for restoring the signal by using the semantic communication signal. In addition, the second device may obtain background knowledge information of the first device based on the semantic communication signal and the information for weekly labeling, and update the background knowledge held by the second device.

In FIG. 22, the procedure for generating a semantic signal through an operation between the first device and the second device is described, but it is only one example for the convenience of explanation and may not be limited to the above-described embodiment. For example, it may also be utilized in various embodiments, such as an operation between a UE and a base station, an operation between UEs (e.g., D2D communication).

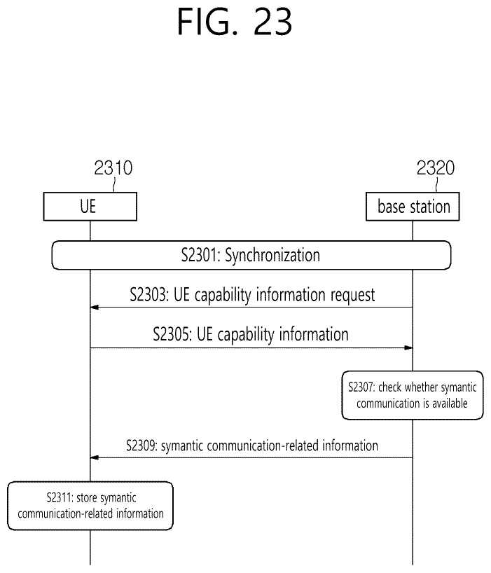

FIG. 23 shows an example of a signal diagram for initial setup of semantic communication according to an embodiment of the present disclosure.

Referring to FIG. 23, at step S2301, the device and the base station may perform synchronization. For example, the device may receive a synchronization signal block (SSB) including a master information block (MIB). The device may perform an initial connection based on the SSB.

At step S2303, the base station may request UE capability information from the device. At step S2305, the device may transmit UE capability information to the base station. The UE capability information is information for whether the UE is capable of performing semantic communication. The base station may request UE capability information from the UE to determine whether semantic communication is performed. The UE capability information may include information for the types of raw data that the UE may generate, collect, or process, and the computational capabilities of the device.

In step S2307, the base station may determine whether the UE may perform semantic communication based on the UE capability information. The following steps S2309 and S2311 may be performed when the base station determines that the UE may perform semantic communication based on the UE capability information.

In step S2309, the base station may transmit semantic communication-related information to the device. In step S2311, the device may store semantic communication-related information. The semantic communication-related information may include at least one of the acquisition unit of semantic data, whether auxiliary information is used, a weekly labeling method according to the type of auxiliary information (e.g., discrete attribute, hierarchical level) (e.g., k (the number of attributes determined in order of high entropy) of FIG. 13, [symbol] (hierarchical level) of FIG. 14), a mini-batch size, an augmentation type and augmentation ratio according to domain knowledge, and information for an encoder model. For example, the semantic communication-related information may be transmitted by being included in at least one of a DCI, a MAC (media access control), or an RRC (radio resource control) message.

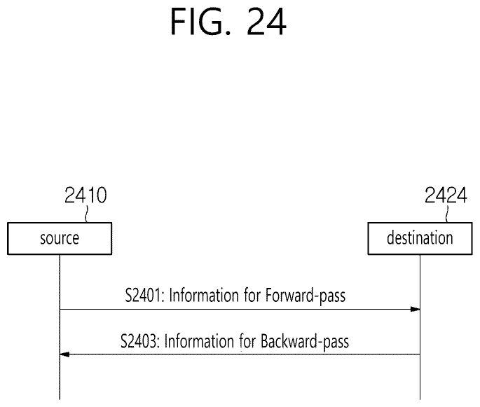

FIG. 24 shows an example of an information exchange diagram of a mini-batch unit according to an embodiment of the present disclosure. When the number of mini-batches is configured to N, 2N augmentation data may be generated from the source. The encoder of the source may encode the 2N augmentation data to generate 2N representations. Thereafter, the source may transmit the generated 2N representations to the destination. In addition, the destination may transmit the corresponding information to the source when there is a change in information for weekly labeling related to the use of auxiliary information.

Referring to FIG. 24, in step S2401, the source may transmit information for a forward-pass to the destination. The information for the forward-pass may include an expression vector and weekly labeling information, which are results of encoding for augmentation data.

In step S2403, the destination may transmit information for a backward-pass to the source. The information for the backward-pass may include gradient information used for learning. At this time, information for weekly labeling may be transmitted together as described above. For example, when discrete attributes are used when weekly labeling is performed, information for k for configuring clusters of the top k attributes may be transmitted. For example, when hierarchical levels are used when weekly labeling is performed, it is possible to transmit [symbol] information for level [symbol] configuration.

Some of the steps described in FIG. 23 and FIG. 24 may be omitted according to the situation or configuration.

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a first device, the method comprising:
receiving, from a second device, a capability information request for the first device;
transmitting, to the second device, capability information of the first device;
receiving, if the first device is a device having semantic communication capability based on the capability information of the first device, from the second device, semantic communication-related information;
generating, based on the semantic communication-related information, a semantic communication signal; and
transmitting, to the second device, the semantic communication signal and information for performing weakly labeling,
wherein the semantic communication signal is generated using shared information and the information for performing the weakly labeling,
wherein the weakly labeling is an operation of providing a weak label to semantic data using the shared information and auxiliary information, and
wherein an update of the shared information is performed based on an operation of a downstream task performed by the second device.

2. The method of claim 1,
wherein the semantic communication signal is used by the second device to perform a downstream task without being decoded into raw data used by the first device to generate representation.

3. The method of claim 1,
wherein the capability information is information for determining whether the first device is available to perform semantic communication, and includes a type of raw data that is available for processing by the first device and computational capability information of the first device.

4. The method of claim 1,
wherein the semantic communication-related information includes at least one of an acquisition unit of the semantic data, information related to performing the weekly labeling, a mini-batch size, an augmentation type and an augmentation ratio, and configuration information of an encoding model,
wherein the semantic data is data extracted from the raw data,
wherein the information for performing the weekly labeling includes the auxiliary information, and
wherein the acquisition unit, the augmentation type, and the augmentation ratio are determined based on the shared information of the first device and the second device.

5. The method of claim 4, further comprising:
obtaining the semantic data from the raw data;
generating weekly labeled semantic data by performing the weekly labeling for the semantic data; and
generating augmentation data from the weekly labeled semantic data.

6. The method of claim 1,
wherein the update of the shared information is performed using a signal converted from the semantic communication signal, and
wherein the converted signal is generated based on a data format used to perform the downstream task.

7. The method of claim 1,
wherein the update of the shared information is performed using a transform head, and
wherein the transform head includes at least one dense layer and at least one non-linear function.

8. The method of claim 1,
wherein the update of the shared information is performed using at least one of a representation used for pre-learning, a representation used for learning to perform the downstream task, and a representation used for inference.

9. The method of claim 8,
wherein the learning for the downstream task is generated based on a first layer of a transform head and at least one layer determined to perform the downstream task.

10. The method of claim 8,
wherein the learning for the downstream task includes a fine-tuning operation or a transfer-learning operation.

11. The method of claim 10,
wherein, after pre-learning is completed, the fine-tuning operation is performed for all networks including a neural network determined according to the downstream task, using weights of an encoder, weights for an additional operation, and weights for the first layer of a transform head.

12. The method of claim 10,
wherein, after pre-learning is completed, the transfer-learning operation is performed for an multi-layer perceptron (MLP) added according to the downstream task, with weights of an encoder, weights for an additional operation, and weights for the first layer of a transform head fixed.

13. The method of claim 1,
wherein the semantic communication signal is transmitted on a layer for semantic communication.

14. A method performed by a second device, the method comprising:
transmitting, to a first device, a capability information request;
receiving, from the first device, capability information;
transmitting, if the first device is a device having semantic communication capability based on the capability information of the first device, to the first device, semantic communication-related information; and
receiving, from the first device, a semantic communication signal and information for performing weakly labeling generated based on the semantic communication-related information,
wherein the semantic communication signal is generated using share information and the information for performing the weakly labeling,
wherein the weakly labeling is an operation of providing a weak label to semantic data using the shared information and auxiliary information, and
wherein an update of the shared information is performed based on an operation of a downstream task performed by the second device.

15. A first device comprising:
a transceiver; and
a processor coupled with the transceiver,
wherein the processor is configured to perform operations comprising:
receiving, from a second device, a capability information request for the first device;
transmitting, to the second device, capability information of the first device;
receiving, if the first device is a device having semantic communication capability based on the capability information of the first device, from the second device, semantic communication-related information;
generating, based on the semantic communication-related information, a semantic communication signal; and
transmitting, to the second device, the semantic communication signal and information for performing weakly labeling,
wherein the semantic communication signal is generated using shared information and the information for performing the weakly labeling,
wherein the weakly labeling is an operation of providing a weak label to semantic data using the shared information and auxiliary information, and
wherein an update of the shared information is performed based on an operation of a downstream task performed by the second device.

16-18. (canceled)

19. The method of claim 14,
wherein the semantic communication signal is used by the second device to perform a downstream task without being decoded into raw data used by the first device to generate representation.

20. The method of claim 14,
wherein the capability information is information for determining whether the first device is available to perform semantic communication, and includes a type of raw data that is available for processing by the first device and computational capability information of the first device.

21. The method of claim 14,
wherein the semantic communication-related information includes at least one of an acquisition unit of the semantic data, information related to performing the weekly labeling, a mini-batch size, an augmentation type and an augmentation ratio, and configuration information of an encoding model,
wherein the semantic data is data extracted from the raw data,
wherein the information for performing the weekly labeling includes the auxiliary information, and
wherein the acquisition unit, the augmentation type, and the augmentation ratio are determined based on the shared information of the first device and the second device.

22. The first device of claim 15,
wherein the semantic communication signal is used by the second device to perform a downstream task without being decoded into raw data used by the first device to generate representation.

23. The first device of claim 15,
wherein the semantic communication signal is used by the second device to perform a downstream task without being decoded into raw data used by the first device to generate representation.
